(19) United States
(12) Patent Application Publication
(10) Pub. No.: US 2025/0070954 A1
(43) Pub. Date: Feb. 27, 2025

(54) SMART COMBINATION SWITCH FOR RAPID SEAMLESS EXTENDED REALITY (XR) CAMERA START AND RECOVERY

(71) Applicant: QUALCOMM Incorporated, San Diego, CA (US)

(72) Inventors: Abhijeet DEY, Bengaluru (IN); Suresh VANKADARA, Hyderabad (IN); Alok KEDIYA, Hyderabad (IN); Ravikishore PAMPANA, Hyderabad (IN); Trishansh BHARDWAJ, Hyderabad (IN)

(21) Appl. No.: 18/455,999

(22) Filed: Aug. 25, 2023

(51) Int. Cl. H04L 7/00; H04N 23/66

(52) U.S. Cl. CPC H04L 7/0016; H04N 23/66

(57) ABSTRACT

Aspects of the disclosure are directed to self-synchronization of information data. In accordance with one aspect, an apparatus includes a receive physical (RX PHY) layer interface configured to send information data to a packet switch configured to suspend transmission of information data prior to arrival of a start of transaction (SOT) field and to commence transmission of information data upon arrival of the SOT field. The apparatus further includes a camera serial interface decoder (CSID) configured to receive information data from the packet switch; a frame switch configured to receive a start of frame (SOF) field from the CSID; an image signal processor (ISP) configured to receive decoded information data from the frame switch and to process decoded information data to generate a processed information data in a format compatible with an image display device; and a software module configured to enable the frame switch and the packet switch.

### TECHNICAL FIELD

This disclosure relates generally to the field of extended reality (XR), and, in particular, to self-synchronization of information data.

### BACKGROUND

In the field of extended reality (XR), a key goal is a faithful representation of a real physical environment. The environment representation is implemented through a synergistic presentation of multiple sensor data streams (e.g., visual, audio, motion, orientation, etc.) obtained from multiple sensors. The multiple sensor data streams may need to be transported from an origination point at one location to a destination point at another location. Since the transport of the multiple sensor data streams may require significant physical resources and stringent synchronization properties, one is motivated to develop a self-synchronized data transport scheme for an XR camera system with multiple sensors.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides self-synchronization of information data. Accordingly, an apparatus for implementing self-synchronization of information data, the apparatus including: a packet switch; a receive physical (RX PHY) layer interface coupled to the packet switch, the RX PHY layer interface configured to send the information data to the packet switch, wherein the packet switch is configured to suspend transmission of the information data prior to arrival of a start of transaction (SOT) field and is configured to commence transmission of the information data upon arrival of the start of transaction (SOT) field.

In one example, the receive physical (RX PHY) layer interface is further configured to send the start of transaction (SOT) field to the packet switch. In one example, the apparatus further includes a software module coupled to the packet switch, wherein the software module is configured to enable the packet switch. In one example, the packet switch is enabled after a sensor activation or an error recovery reset.

In one example, the apparatus further includes a camera serial interface (CSI) decoder (CSID) coupled to the packet switch, wherein the CSID is configured to receive the information data from the packet switch. In one example, the apparatus further includes a frame switch coupled to the CSID, wherein the frame switch is configured to receive a start of frame (SOF) field from the CSID.

In one example, the CSID is further configured to decode the information data to generate a decoded information data to send to the frame switch. In one example, the frame switch is further configured to suspend transmission of a first set of frames in the decoded information data prior to arrival of a start of frame (SOF) field. In one example, the frame switch is further configured to commence transmission of a second set of frames in the decoded information data upon arrival of the SOF field.

In one example, the apparatus further includes an image signal processor (ISP) coupled to the frame switch, wherein the ISP is configured to receive the decoded information data from the frame switch. In one example, the ISP is further configured to process the decoded information data to generate a processed information data in a format compatible with an image display device.

In one example, the apparatus further includes a software module coupled to the frame switch, wherein the software module is configured to enable the frame switch. In one example, the frame switch is enabled after a sensor activation or an error recovery reset.

Another aspect of the disclosure provides a method for implementing self-synchronization of information data, the method including: determining whether there is arrival of a start of transaction (SOT) field; suspending transmission of a first set of packets in an information data prior to arrival of the start of transaction (SOT) field; and commencing transmission of a second set of packets in the information data upon the arrival of the start of transaction (SOT) field.

In one example, the method further includes receiving the start of transaction (SOT) field from a receive physical (RX PHY) layer interface. In one example, the transmission of the second set of packets is over a single lane interface. In one example, the single lane interface includes one lane of information data at its output. In one example, the transmission of the second set of packets is over a multiple lane interface. In one example, the multiple lane interface includes two or more lanes of information data at its output.

In one example, the method further includes determining whether there is arrival of a start of frame (SOF) field. In one example, the method further includes suspending transmission of a first set of frames in the information data prior to arrival of the start of frame (SOF) field. In one example, the method further includes commencing transmission of the second set of frames in the information data upon the arrival of the SOF field. In one example, the method further includes enabling a frame switch to commence the transmission of the second set of frames.

In one example, the frame switch is enabled after a sensor activation or an error recovery reset. In one example, the method further includes enabling a packet switch to commence the transmission of the second set of packets. In one example, the packet switch is enabled after the sensor activation or the error recovery reset.

Another aspect of the disclosure provides An apparatus for implementing self-synchronization of information data, the apparatus including: means for determining whether there is arrival of a start of transaction (SOT) field; means for suspending transmission of a first set of packets in an information data prior to arrival of the start of transaction (SOT) field; and means for commencing transmission of a second set of packets in the information data upon the arrival of the start of transaction (SOT) field.

In one example, the apparatus further includes: means for determining whether there is arrival of a start of frame (SOF) field; means for suspending transmission of a first set of frames in the information data prior to arrival of the start of frame (SOF) field; and means for commencing transmission of the second set of frames in the information data upon the arrival of the SOF field.

Another aspect of the disclosure provides a non-transitory computer-readable medium storing computer executable code, operable on a device including at least one processor and at least one memory coupled to the at least one processor, wherein the at least one processor is configured to implement self-synchronization of information data, the computer executable code including: instructions for causing a computer to determine whether there is arrival of a start of transaction (SOT) field; instructions for causing the computer to suspend transmission of a first set of packets in an information data prior to arrival of the start of transaction (SOT) field; and instructions for causing the computer to commence transmission of a second set of packets in the information data upon the arrival of the start of transaction (SOT) field.

In one example, the non-transitory computer-readable further includes instructions for causing the computer to perform the following: determine whether there is arrival of a start of frame (SOF) field; suspend transmission of a first set of frames in the information data prior to arrival of the start of frame (SOF) field; and commence transmission of the second set of frames in the information data upon the arrival of the SOF field.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example of an extended reality (XR) camera system.

FIG. 2 illustrates an example of a single sensor data flow for a single sensor.

FIG. 3 illustrates an example of a multiple sensor data flow for a plurality of sensors.

FIG. 4 illustrates an example of a camera serial interface (CSI) decoder (CSID) operation.

FIG. 5 illustrates an example of an image signal processor (ISP) operation.

FIG. 6 illustrates an example of a first XR data fault scenario with an extended reality (XR) camera system.

FIG. 7 illustrates an example of a second XR data fault scenario with an extended reality (XR) camera system.

FIG. 8 illustrates an example of an extended reality (XR) system with a smart combination switch for a single lane interface.

FIG. 9 illustrates an example of an extended reality (XR) system with a smart combination switch for a multiple lane interface.

FIG. 10 illustrates an example flow diagram of self-synchronization of information data for an extended reality (XR) system with a smart combination switch.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

An extended reality (XR) system may employ a plurality of sensors which generates a plurality of sensor data streams. In one example, the plurality of sensor data streams is processed subsequently to produce a representation or emulation of a real physical environment. The XR system may be used for technical or entertainment purposes. For example, the plurality of sensors may include a visual sensor, an audio sensor, a motion sensor, an orientation sensor, etc. Each sensor of the plurality of sensors may produce a sensor data stream. In one example, the sensor data stream is a digital representation of a sensor signal input. For example, a visual sensor data stream may be a digital representation of the visual sensor, an audio sensor data stream may be a digital representation of the audio sensor, the motion sensor data stream may be a digital representation of the motion sensor, and/or the orientation sensor data stream may be a digital representation of the orientation sensor, etc.

In one example, each sensor data stream of the plurality of sensor data streams may be formatted as a plurality of frames, where each frame is a group of sensor data consisting of a plurality of lines. In one example, each line of the plurality of lines may include a plurality of pixels (i.e., picture elements).

In one example, each frame may include a plurality of packets, where a packet is a group of fields having a variable quantity of bits. For example, each packet may include a first field which is a start of transaction (SOT) field. For example, each packet may include a second field which is a payload field. For example, each packet may include a third field which is an end of transaction (EOT) field. In one example, the payload field may be a start of frame (SOF) field, a line of pixel data, or an end of frame (EOF) field.

In one example, each frame includes a first packet which contains the SOF field to indicate a start of a frame. In one example, each frame includes a plurality of packets which correspond to a plurality of lines, where each line includes a line of pixel data. In one example, each frame includes a final packet which contains the EOF field to indicate an end of the frame.

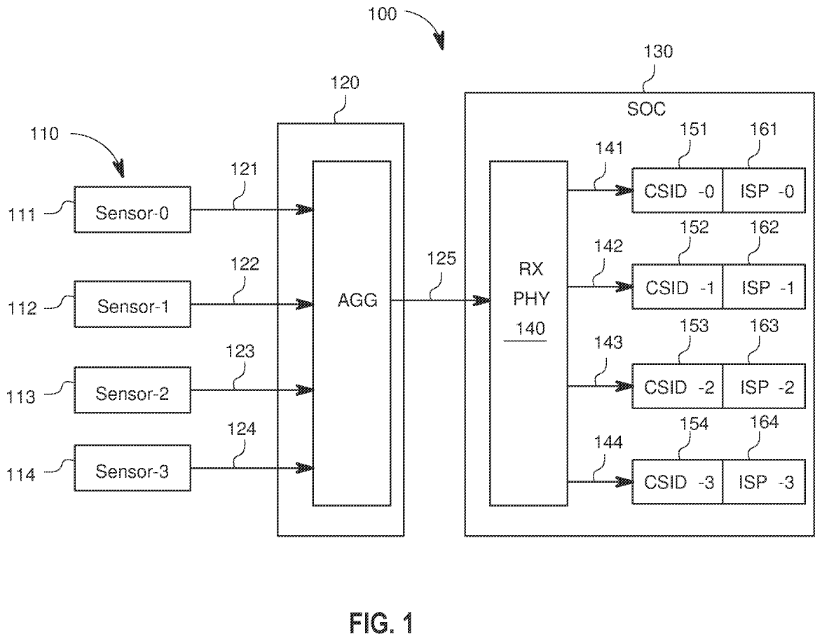

FIG. 1 illustrates an example of an extended reality (XR) camera system 100. In one example, the XR camera system 100 includes a plurality of sensors 110, with a first sensor (Sensor-0) 111, a second sensor (Sensor-1) 112, a third sensor (Sensor-2) 113 and a fourth sensor (Sensor-3) 114. For example, the plurality of sensors 110 may include sensors for head tracking (HET), hand tracking (HAT), eye tracking (ET), plane finding (PF), etc.

In one example, a plurality of individual sensor data streams from the plurality of sensors 110 is sent to an aggregator 120 with a plurality of aggregator inputs. In one example, each individual sensor data stream is transported over an individual sensor transmission line. In one example, a quantity of individual sensor transmission lines is equal to a quantity of sensors in the plurality of sensors. In one example, the plurality of aggregator inputs includes a first aggregator input 121 which receives a first individual sensor data stream from the first sensor 111, a second aggregator input 122 which receives a second individual sensor data stream from the second sensor 112, a third aggregator input 123 which receives a third individual sensor data stream from the third sensor 113 and a fourth aggregator input 124 which receives a fourth individual sensor data stream from the fourth sensor 114.

In one example, the aggregator 120 combines (i.e., aggregates) the plurality of individual sensor data streams from the plurality of sensors 110 into a multiplexed sensor data stream over a single composite data link 125. In one example, the single composite data link 125 may be a mobile industry processor interface (MIPI) link. In one example, one feature of the aggregator 120 is that a quantity of interconnection transmission lines from the plurality of sensors 110 is reduced to a single interconnection transmission line between the aggregator 120 and a system on a chip (SOC) 130. In one example, each individual sensor data stream operates at a data rate of at least 1 gigabit per second (Gb/s).

In one example, the SOC 130 receives the multiplexed sensor data stream over the single composite data link 125 through a receive physical (RX PHY) layer interface 140. In one example, the RX PHY layer interface 140 receives the multiplexed sensor data stream and demultiplexes it into a plurality of demultiplexed sensor data streams. In one example, the quantity of the plurality of demultiplexed sensor data streams is the same as the quantity of the plurality of individual sensor data streams from the plurality of sensors 110. In one example, there is a one-to-one correspondence between each of the plurality of demultiplexed sensor data streams and each of the plurality of individual sensor data streams from the plurality of sensors 110. In one example, the corresponding sensor data streams are identical.

In one example, a first demultiplexed sensor data stream 141 is sent to a first camera serial interface (CSI) decoder (CSID-0) 151, a second demultiplexed sensor data stream 142 is sent to a second CSI decoder (CSID-1) 152, a third demultiplexed sensor data stream 143 is sent to a third CSI decoder (CSID-2) 153 and a fourth demultiplexed sensor data stream 144 is sent to a fourth CSI decoder (CSID-3) 154. In one example, the first demultiplexed sensor data stream 141 is the same as the first individual sensor data stream, the second demultiplexed sensor data stream 142 is the same as the second individual sensor data stream, the third demultiplexed sensor data stream 143 is the same as the third individual sensor data stream, and the fourth demultiplexed sensor data stream 144 is the same as the fourth individual sensor data stream. In the example, herein, “the same as” means that the sensor data streams are identical.

In one example, the SOC 130 processes the first demultiplexed sensor data stream 141 with the first CSI decoder (CSID-0) 151 and a first image signal processor (ISP-0) 161. In one example, the SOC 130 processes the second demultiplexed sensor data stream 142 with the second CSI decoder (CSID-1) 152 and a second image signal processor (ISP-1) 162. In one example, the SOC 130 processes the third demultiplexed sensor data stream 143 with the third CSI decoder (CSID-2) 153 and a third image signal processor (ISP-2) 163. In one example, the SOC 130 processes the fourth demultiplexed sensor data stream 144 with the fourth CSI decoder (CSID-3) 154 and a fourth image signal processor (ISP-3) 164.

In one example, the first CSI decoder 151 decodes a first set of data packets originating from the first sensor 111 into a first set of pixel data. In one example, the second CSI decoder 152 decodes a second set of data packets originating from the second sensor 112 into a second set of pixel data. In one example, the third CSI decoder 153 decodes a third set of data packets originating from the third sensor 113 into a third set of pixel data. In one example, the fourth CSI decoder 154 decodes a fourth set of data packets originating from the fourth sensor 114 into a fourth set of pixel data. In one example, the first set of pixel data is a first decoded information data, and the second set of pixel data is a second decoded information data, etc.

In one example, the first image signal processor (ISP-0) 161 processes the first set of pixel data in a frame. For example, the first set of pixel data originates in the first sensor 111. In one example, the second image signal processor (ISP-1) 162 processes the second set of pixel data in the frame. For example, the second set of pixel data originates in the second sensor 112. In one example, the third image signal processor (ISP-2) 163 processes the third set of pixel data in the frame. For example, the third set of pixel data originates in the third sensor 113. In one example, the fourth image signal processor (ISP-3) 164 processes the fourth set of pixel data in the frame. For example, the fourth set of pixel data originates in the fourth sensor 114. In one example, the first ISP 161 generates a first processed information data. In one example, the first processed information data is formatted to be compatible with an image display device (not shown).

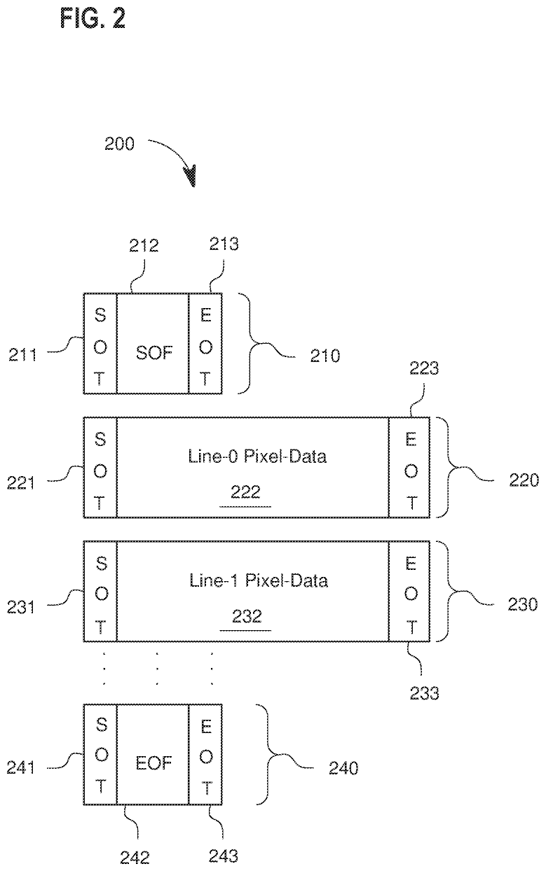

FIG. 2 illustrates an example of a single sensor data flow 200 for a single sensor. In one example, the single sensor data flow 200 commences with a first packet 210. In one example. the first packet 210 includes a first start of transaction (SOT) field 211, a start of frame (SOF) field 212 and a first end of transaction (EOT) field 213. In one example, the single sensor data flow 200 includes a second packet 220. In one example, the second packet 220 includes a second SOT field 221, a first line of pixel data 222, and a second EOT field 223. In one example, the single sensor data flow 200 includes a third packet 230. In one example, the third packet 230 includes a third SOT field 231, a second line of pixel data 232, and a third EOT field 233. In one example, the single sensor data flow 200 continues with a plurality of packets (not shown) with each packet of the plurality of packets having a SOT field, a line of pixel data and an EOT field. In one example, the single sensor data flow 200 includes a final packet 240. In one example, the final packet 240 includes a final start of transaction (SOT) field 241, an end of frame (EOF) field 242 and a final end of transaction (EOT) field 243.

In one example, the single sensor data flow 200 commences a frame start with the first packet 210 containing the SOF field 212 to indicate a beginning of a frame. In one example, subsequent packets contain a plurality of lines of pixel data. In one example, the single sensor data flow 200 terminates a frame with the final packet 240 containing the EOF field 242 to indicate an end of the frame. In one example, each packet starts with a SOT field and ends with an EOT field.

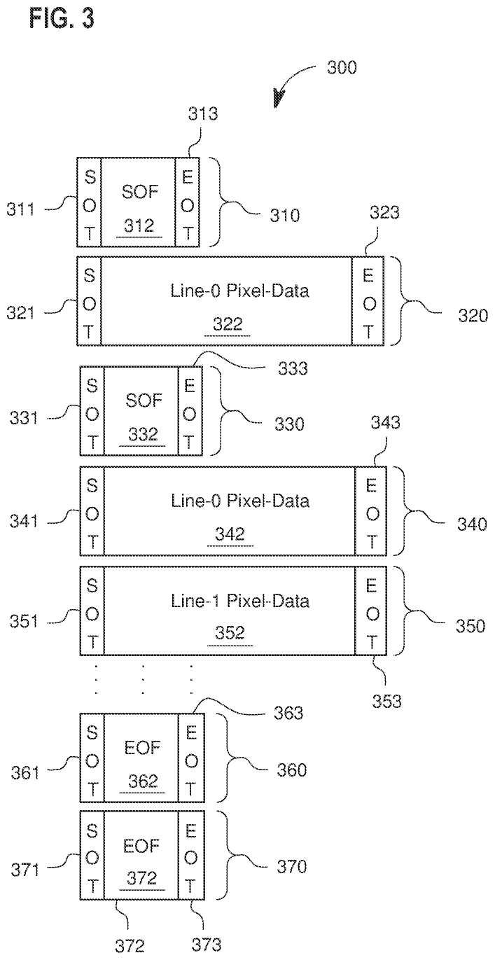

FIG. 3 illustrates an example of a multiple sensor data flow 300 for a plurality of sensors. In one example, the multiple sensor data flow 300 commences with a first packet 310. In one example, the first packet 310 includes a first start of transaction (SOT) field 311, a first start of frame (SOF) field 312 and a first end of transaction (EOT) field 313. In one example, the first SOF field 312 is associated with the first sensor 111 to indicate a start of frame with the first individual sensor data stream.

In one example, the multiple sensor data flow 300 includes a second packet 320. In one example, the second packet 320 includes a second SOT field 321, a first line of pixel data 322, and a second EOT field 323. In one example, the first line of pixel data 322 originates from the first sensor 111.

In one example, the multiple sensor data flow 300 includes a third packet 330. In one example, the third packet 330 includes a third SOT field 331, a second SOF field 332 and a third EOT field 333. In one example, the second SOF field 332 is associated with the second sensor 112 to indicate a start of frame with the sensor individual sensor data stream.

In one example, the multiple sensor data flow 300 includes a fourth packet 340. In one example, the fourth packet 340 includes a fourth SOT field 341, a second line of pixel data 342, and a fourth EOT field 343. In one example, the second line of pixel data 342 originates from the second sensor 112.

In one example, the multiple sensor data flow 300 includes a fifth packet 350. In one example, the fifth packet 350 includes a fifth SOT field 351, a third line of pixel data 352, and a fifth EOT field 353. In one example, the first line of pixel data 322 originates from the first sensor 111.

In one example, the multiple sensor data flow 300 continues with a plurality of packets (not shown) with each packet of the plurality of packets having a SOT field, a line of pixel data and an EOT field.

In one example, the multiple sensor data flow 300 includes a next to final packet 360. In one example, the next to final packet 360 includes a SOT field 361, a first EOF field 362 and an EOT field 363. In one example, the first EOF field 362 is associated with the first sensor 111 to indicate an end of frame with the first individual sensor data stream.

In one example, the multiple sensor data flow 300 includes a final packet 370. In one example, the final packet 370 includes a SOT field 371, a second EOF field 372 and an EOT field 373. In one example, the second EOF field 372 is associated with the second sensor 112 to indicate an end of frame with the second individual sensor data stream.

In one example, the multiple sensor data flow 300 is sent from the aggregator 120 (shown in FIG. 1) to the SOC 130 (shown in FIG. 1). In one example, the multiple sensor data flow 300 includes packets from different sensors which are interleaved by the aggregator 120 to form the multiplexed sensor data stream.

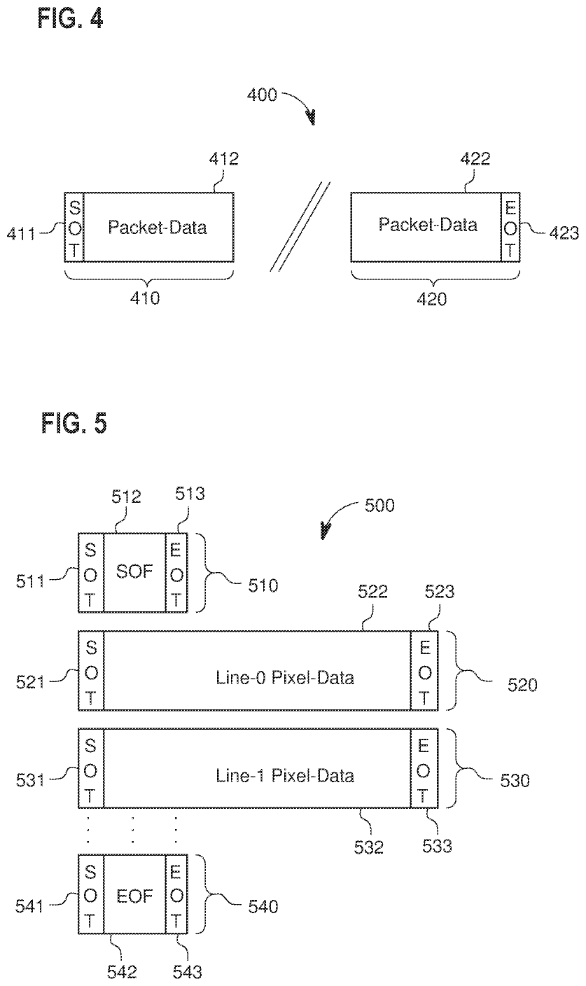

FIG. 4 illustrates an example of a camera serial interface (CSI) decoder (CSID) operation 400. In one example, the CSID receives a packet transmission including a first packet segment 410 and a second packet segment 420. In one example, a packet segment is a portion of a packet. For example, the first packet segment 410 may include an SOT field 411 and a first payload field 412, which contains a first packet data. For example, the second packet segment 420 may include a second payload field 422, which contains a second packet data, and an EOT field 423.

In one example, the CSID operates at a packet level, from the SOT field 411 to the EOT field 423. In one example, if the CSID is activated (i.e., switched on) asynchronously in a middle of a packet transmission, then a hardware fault or violation results (i.e., an incomplete packet transmission is received). For example, the CSID may commence operation starting at the SOT field 411, which denotes a beginning of a packet. For example, if the CSID is activated in the middle of the packet transmission, this packet asynchronicity may result in a hardware fault.

FIG. 5 illustrates an example of an image signal processor (ISP) operation 500. In one example, the ISP receives a frame transmission including a first packet 510, a second packet 520, a third packet 530 and a fourth packet 540. For example, the first packet 510 may include a first SOT field 511, an SOF field 512 and a first EOT field 513. For example, the second packet 520 may include a second SOT field 521, a first payload field 522 and a second EOT field 523. For example, the third packet 530 may include a third SOT field 531, a second payload field 532 and a third EOT field 533. For example, the fourth packet 540 may include a fourth SOT field 541, an EOF field 542 and a fourth EOT field 543.

In one example, the ISP operates at a frame level, from the SOF field 512 to the EOF field 542. In one example, if the ISP is activated (i.e., switched on) asynchronously in a middle of a frame transmission, then a hardware fault or violation results (i.e., an incomplete frame transmission is received with unbounded frame errors). For example, the ISP ideally should commence operation starting at the SOF field 512, which denotes a beginning of a frame. However, if the ISP is activated in the middle of the frame transmission, this frame asynchronicity may result in a hardware fault.

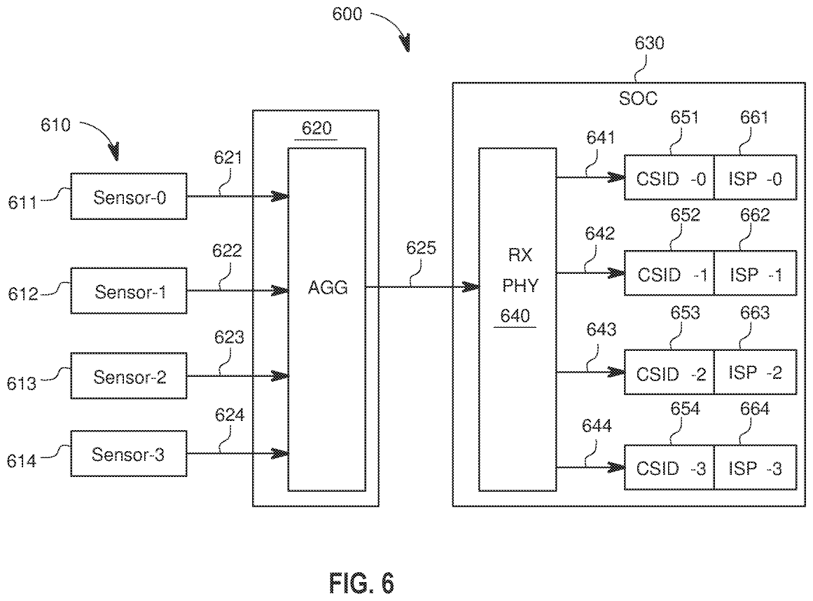

FIG. 6 illustrates an example of a first XR data fault scenario with an extended reality (XR) camera system 600. In one example, the XR camera system 600 includes a plurality of sensors 610, with a first sensor (Sensor-0) 611, a second sensor (Sensor-1) 612, a third sensor (Sensor-2) 613 and a fourth sensor (Sensor-3) 614. For example, the plurality of sensors 610 may include sensors for head tracking (HET), hand tracking (HAT), eye tracking (ET), plane finding (PF), etc.

In one example, a plurality of individual sensor data streams from the plurality of sensors 610 is sent to an aggregator 620 with a plurality of aggregator inputs. In one example, each individual sensor data stream is transported over an individual sensor transmission line. For example, a quantity of individual sensor transmission lines may be equal to a quantity of sensors in the plurality of sensors. In one example, the plurality of aggregator inputs includes a first aggregator input 621 which receives a first individual sensor data stream from the first sensor 611, a second aggregator input 622 which receives a second individual sensor data stream from the second sensor 612, a third aggregator input 623 which receives a third individual sensor data stream from the third sensor 613 and a fourth aggregator input 624 which receives a fourth individual sensor data stream from the fourth sensor 614.

In one example, the aggregator 620 combines (i.e., aggregates) the plurality of individual sensor data streams from the plurality of sensors 610 into a multiplexed sensor data stream over a single composite data link 625. In one example, the single composite data link 625 may be a mobile industry processor interface (MIPI) link. In one example, each individual sensor data stream operates at a data rate of at least 1 gigabit per second (Gb/s).

In one example, the SOC 630 receives the multiplexed sensor data stream over the single composite data link 625 through a receive physical (RX PHY) layer interface 640. In one example, the RX PHY layer interface 640 receives the multiplexed sensor data stream and demultiplexes it into a plurality of demultiplexed sensor data streams. In one example, the plurality of demultiplexed sensor data streams is the same as the plurality of individual sensor data streams from the plurality of sensors 610. In one example, a first demultiplexed sensor data stream 641 is sent to a first camera serial interface (CSI) decoder (CSID-0) 651, a second demultiplexed sensor data stream 642 is sent to a second CSI decoder (CSID-1) 652, a third demultiplexed sensor data stream 643 is sent to a third CSI decoder (CSID-2) 653 and a fourth demultiplexed sensor data stream 644 is sent to a fourth CSI decoder (CSID-3) 654.

In one example, the first demultiplexed sensor data stream 641 is the same as the first individual sensor data stream, the second demultiplexed sensor data stream 642 is the same as the second individual sensor data stream, the third demultiplexed sensor data stream 643 is the same as the third individual sensor data stream, and the fourth demultiplexed sensor data stream 644 is the same as the fourth individual sensor data stream. In the example, herein, “the same as” means that the sensor data streams are identical.

In one example, the SOC 630 processes the first demultiplexed sensor data stream 641 with the first CSI decoder (CSID-0) 651 and a first image signal processor (ISP-0) 661. In one example, the SOC 630 processes the second demultiplexed sensor data stream 642 with the second CSI decoder (CSID-1) 652 and a second image signal processor (ISP-1) 662. In one example, the SOC 630 processes the third demultiplexed sensor data stream 643 with the third CSI decoder (CSID-2) 653 and a third image signal processor (ISP-2) 663. In one example, the SOC 630 processes the fourth demultiplexed sensor data stream 644 with the fourth CSI decoder (CSID-3) 654 and a fourth image signal processor (ISP-3) 664.

In one example, the first CSI decoder 651 decodes a first set of data packets originating from the first sensor 611 into a first set of pixel data. In one example, the second CSI decoder 652 decodes a second set of data packets originating from the second sensor 612 into a second set of pixel data. In one example, the third CSI decoder 653 decodes a third set of data packets originating from the third sensor 613 into a third set of pixel data. In one example, the fourth CSI decoder 654 decodes a fourth set of data packets originating from the fourth sensor 614 into a fourth set of pixel data.

In one example, the first image signal processor (ISP-0) 661 processes the first set of pixel data in a frame. For example, the first set of pixel data originates in the first sensor 611. In one example, the second image signal processor (ISP-1) 662 processes the second set of pixel data in the frame. For example, the second set of pixel data originates in the second sensor 612. In one example, the third image signal processor (ISP-2) 663 processes the third set of pixel data in the frame. For example, the third set of pixel data originates in the third sensor 613. In one example, the fourth image signal processor (ISP-3) 664 processes the fourth set of pixel data in the frame. For example, the fourth set of pixel data originates in the fourth sensor 614.

In one example, initially the first sensor 611, the second sensor 612 and the third sensor 613 are activated (e.g., for head tracking, eye tracking, and plane finding). In one example, after a time duration, an application may request that the fourth sensor 614 be activated (e.g., for hand tracking). In one example, the first sensor 611, the second sensor 612 and the third sensor 613 (i.e., the active sensors) may require a halt in operation and to be restarted synchronously with the activation of the fourth sensor 614. For example, the halt may be required when the fourth CSID 654 is activated asynchronously, with respect to the other CSIDs 651, 652 and 653, and the halt may start in a middle of packet transmission for other sensors. In one example, the activation of the fourth CSID 654 may result in a hardware violation. In one example, as a result, all sensors may be halted and restarted together, which leads to an operational interruption.

In one example, the halting of all sensors and of the entire XR system is disruptive to a user experience. In one example, frame drops may occur in the active sensors (i.e., the first sensor 611, the second sensor 612 and the third sensor 613). In one example, there may be high latency to activate a new sensor since all other sensors need to be halted first. For example, the operational interruption may be due to the operational procedure used with the aggregator 620.

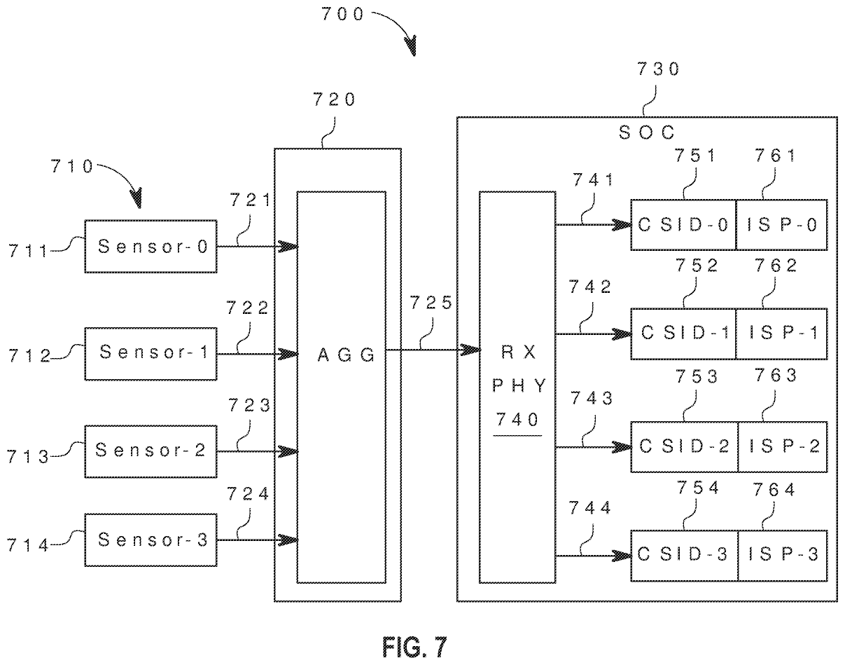

FIG. 7 illustrates an example of a second XR data fault scenario with an extended reality (XR) camera system 700. In one example, the XR camera system 700 includes a plurality of sensors 710, with a first sensor (Sensor-0) 711, a second sensor (Sensor-1) 712, a third sensor (Sensor-2) 713 and a fourth sensor (Sensor-3) 714. For example, the plurality of sensors 710 may include sensors for head tracking (HET), hand tracking (HAT), eye tracking (ET), plane finding (PF), etc.

In one example, a plurality of individual sensor data streams from the plurality of sensors 710 is sent to an aggregator 720 with a plurality of aggregator inputs. In one example, each individual sensor data stream is transported over an individual sensor transmission line. For example, a quantity of individual sensor transmission lines is equal to a quantity of sensors in the plurality of sensors. In one example, the plurality of aggregator inputs includes a first aggregator input 721 which receives a first individual sensor data stream from the first sensor 711, a second aggregator input 722 which receives a second individual sensor data stream from the second sensor 712, a third aggregator input 723 which receives a third individual sensor data stream from the third sensor 713 and a fourth aggregator input 724 which receives a fourth individual sensor data stream from the fourth sensor 714.

In one example, the aggregator 720 combines (i.e., aggregates) the plurality of individual sensor data streams from the plurality of sensors 710 into a multiplexed sensor data stream over a single composite data link 725. In one example, the single composite data link 725 may be a mobile industry processor interface (MIPI) link. In one example, each individual sensor data stream operates at a data rate of at least 1 gigabit per second (Gb/s).

In one example, the SOC 730 receives the multiplexed sensor data stream over the single composite data link 725 through a receive physical (RX PHY) layer interface 740. In one example, the RX PHY layer interface 740 receives the multiplexed sensor data stream and demultiplexes it into a plurality of demultiplexed sensor data streams.

In one example, the plurality of demultiplexed sensor data streams is the same as the plurality of individual sensor data streams from the plurality of sensors 710. In one example, a first demultiplexed sensor data stream 741 is sent to a first camera serial interface (CSI) decoder (CSID-0) 751, a second demultiplexed sensor data stream 742 is sent to a second CSI decoder (CSID-1) 752, a third demultiplexed sensor data stream 743 is sent to a third CSI decoder (CSID-2) 753 and a fourth demultiplexed sensor data stream 744 is sent to a fourth CSI decoder (CSID-3) 754.

In one example, the first demultiplexed sensor data stream 741 is the same as the first individual sensor data stream, the second demultiplexed sensor data stream 742 is the same as the second individual sensor data stream, the third demultiplexed sensor data stream 743 is the same as the third individual sensor data stream, and the fourth demultiplexed sensor data stream 744 is the same as the fourth individual sensor data stream. In the example, herein, “the same as” means that the sensor data streams are identical.

In one example, the SOC 730 processes the first demultiplexed sensor data stream 741 with the first CSI decoder (CSID-0) 751 and a first image signal processor (ISP-0) 761, the second demultiplexed sensor data stream 742 with the second CSI decoder (CSID-1) 752 and a second image signal processor (ISP-1) 762, the third demultiplexed sensor data stream 743 with the third CSI decoder (CSID-2) 753 and a third image signal processor (ISP-2) 763, and the fourth demultiplexed sensor data stream 744 with the fourth CSI decoder (CSID-3) 754 and a fourth image signal processor (ISP-3) 764.

In one example, the first CSI decoder 751 decodes a first set of data packets originating from the first sensor 711 into a first set of pixel data. In one example, the second CSI decoder 752 decodes a second set of data packets originating from the second sensor 712 into a second set of pixel data. In one example, the third CSI decoder 753 decodes a third set of data packets originating from the third sensor 713 into a third set of pixel data. In one example, the fourth CSI decoder 754 decodes a fourth set of data packets originating from the fourth sensor 714 into a fourth set of pixel data.

In one example, the first image signal processor (ISP-0) 761 processes the first set of pixel data in a frame. For example, the first set of pixel data originates in the first sensor 711. In one example, the second image signal processor (ISP-1) 762 processes the second set of pixel data in the frame. For example, the second set of pixel data originates in the second sensor 712. In one example, the third image signal processor (ISP-2) 763 processes the third set of pixel data in the frame. For example, the third set of pixel data originates in the third sensor 713. In one example, the fourth image signal processor (ISP-3) 764 processes the fourth set of pixel data in the frame. For example, the fourth set of pixel data originates in the fourth sensor 714.

In one example, a transient link error may occur in the single composite data link 725 between the aggregator 720 and the SOC 730. In one example, the transient link error may propagate to one of the CSI decoders and cause a CSI decoder error in an errored CSI decoder, e.g., the first CSI decoder 751, the second CSI decoder 752, the third CSI decoder 753 or the fourth CSI decoder 754. In one example, the errored CSI decoder executes a reset for error recovery. For example, after reset all non-errored sensors may need to be halted and restarted along with the errored sensor.

In one example, if one CSI decoder assigned to one sensor is activated asynchronously, then the CSI decoder may commence operation in a middle of packet transmission from other sensors. In one example, if one ISP assigned to the one sensor is activated asynchronously, then the ISP may commence operation in a middle of packet transmission from the other sensors. As a result, a hardware violation or fault may occur in the one CSI decoder or the one ISP.

In one example, the halting of all sensors and of the entire XR system is disruptive to a user experience. In one example, the first sensor 711 has an error. However, frame drops may occur in the non-errored sensors (i.e., the second sensor 712, the third sensor 713 and the fourth sensor 714). In one example, there may be high latency in the recovery since all other sensors need to be halted first. For example, the operational interruption is due to the operational procedure used with the aggregator 720.

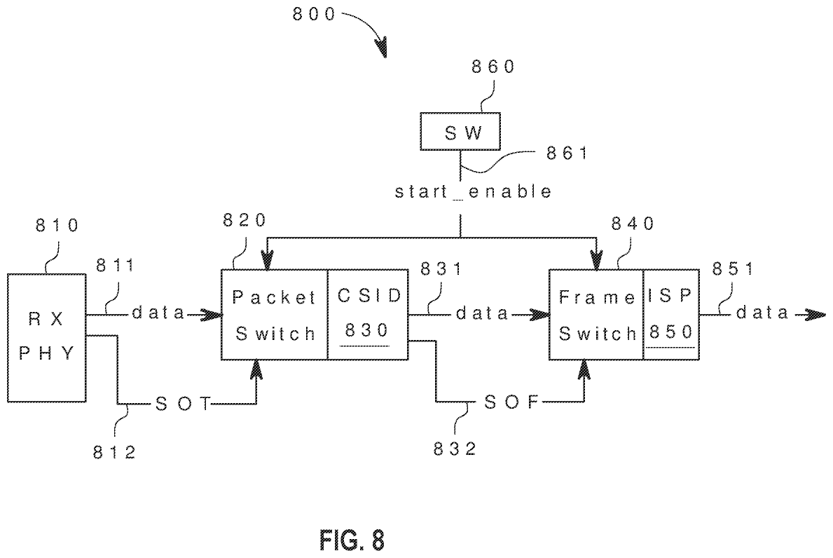

FIG. 8 illustrates an example of an extended reality (XR) system 800 with a smart combination switch for a single lane interface. In one example, a lane is a physical transmission path between a sender and a receiver. In one example, a single lane interface is a hardware module which receives one lane of information data at its input or sends one lane of information data at its output.

In one example, the XR system 800 includes a RX PHY layer interface 810 which sends information data 811 and an SOT field 812 to a packet switch 820. In one example, the packet switch 820 sends the information data 811 to a camera serial interface (CSI) decoder (CSID) 830. In one example, the CSID 830 decodes the information data 811 and sends the decoded information data 831 and an SOF field 832 to a frame switch 840. In one example, the frame switch 840 sends the decoded information data 831 to an image signal processor (ISP) 850. In one example, the ISP processes the decoded information data 831 to generate a processed information data 851.

In one example, the ISP 850 sends the processed information data 851 to a user application hosted on a user processor platform (not shown). In one example, the processed information data 851 is formatted to be compatible with an image display device (not shown). In one example, a software module 860, hosted on a processor (not shown), sends an enable signal (e.g., start_enable) 861 to the packet switch 820 and to the frame switch 840.

In one example, the packet switch 820, prior to sending the information data 811 to the CSID 830, is enabled by the software module 860 using a configuration signal. In one example, the configuration signal is the enable signal 861. In one example, the enablement of the CSID is executed after activating a sensor or after a reset during error recovery.

In one example, the packet switch 820 suspends transmission of packets in information data 811 from the RX PHY layer interface 810 to the CSID 830 until the SOT field 812 arrives at the packet switch 820. In one example, the packet switch 820 commences transmission of packets in information data 811 from the RX PHY layer interface 810 to the CSID 830 after the SOT field 812 arrives at the packet switch 820.

In one example, all packets in information data 811 from the RX PHY layer interface 810 to the CSID 830 are dropped prior to arrival of the SOT field 812. In one example, the dropped packets ensure that the CSID 830 only operates on complete packets, (i.e., not packet segments) after the SOT field 812 arrives.

In one example, the frame switch 840, prior to sending the decoded information data 831 to the ISP 850, is enabled by the software module 860 using a configuration signal. In one example, the configuration signal is the enable signal 861. In one example, the enablement of the ISP is executed after activating a sensor or after a reset during error recovery.

In one example, the frame switch 840 suspends transmission of frames in decoded information data 831 from the CSID 830 to the ISP 850 until the SOF field 832 arrives at the frame switch 840. In one example, the frame switch 840 commences transmission of frames in decoded information data 831 from the CSID 830 to the ISP 850 after the SOF field 832 arrives at the frame switch 840.

In one example, all frames in decoded information data 831 from the CSID 830 to the ISP 850 are dropped prior to arrival of the SOF field 832. In one example, the dropped frames ensure that the ISP 850 only operates on complete frames (i.e., not frame segments) after the SOF field 832 arrives.

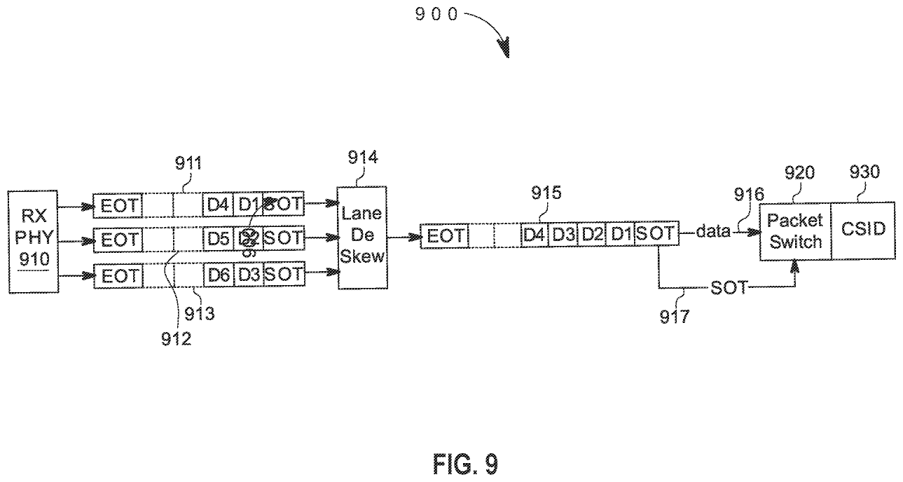

FIG. 9 illustrates an example of an extended reality (XR) system 900 with a smart combination switch for a multiple lane interface. In one example, a lane is a physical transmission path between a sender and a receiver. In one example, a multiple lane interface is a hardware module which receives one lane of information data at its input or sends more than one lane of information data at its output. In one example, the multiple lane interface may introduce skew, i.e., timing offsets, among each lane at its output.

In one example, the XR system 900 includes a RX PHY layer interface 910 which sends a first information data 911 on a first lane, a second information data 912 on a second lane and a third information data 913 on a third lane as a multi-lane PHY data flow to a lane deskew module 914. In one example, each information data includes a SOT field, a plurality of data fields and an EOT field.

In one example, the lane deskew module 914 executes a timing deskew on each lane to eliminate or minimize skew, or timing offsets, among each lane. In one example, the lane deskew module 914 combines each lane into a consolidated lane 915. In one example, the consolidated lane 915 is formatted as a single lane with a consolidated information data 916. In one example, the consolidated information data 916 is a superposition of the first information data 911, the second information data 912 and the third information data 913 on the consolidated lane 915.

In one example, the consolidated information data 916 and a consolidated SOT field 917 are sent to the packet switch 920. In one example, the consolidated information data 916 is sent from the packet switch 920 to the CSID 930.

In one example, information data from the RX PHY layer interface 910 is distributed among a plurality of lanes. For example, each lane has an individual SOT field and an individual EOT field. In one example, the lane deskew module 914 is used to deskew and merge the plurality of lanes to form a single packet for the consolidated information data 916. In one example, the consolidated SOT field 917 and a consolidated EOT field are generated by the lane deskew module 914 and sent to the packet switch 920 after the deskew and merge. In one example, merge means to combine, for example, combining the plurality of lanes to form a single packet.

In one example, the packet switch 920 operates after the lane deskew module 914 has performed deskewing and merging. In one example, the consolidated SOT field 917 is used by the packet switch 920 to enable transmission of packets to the CSID 930.

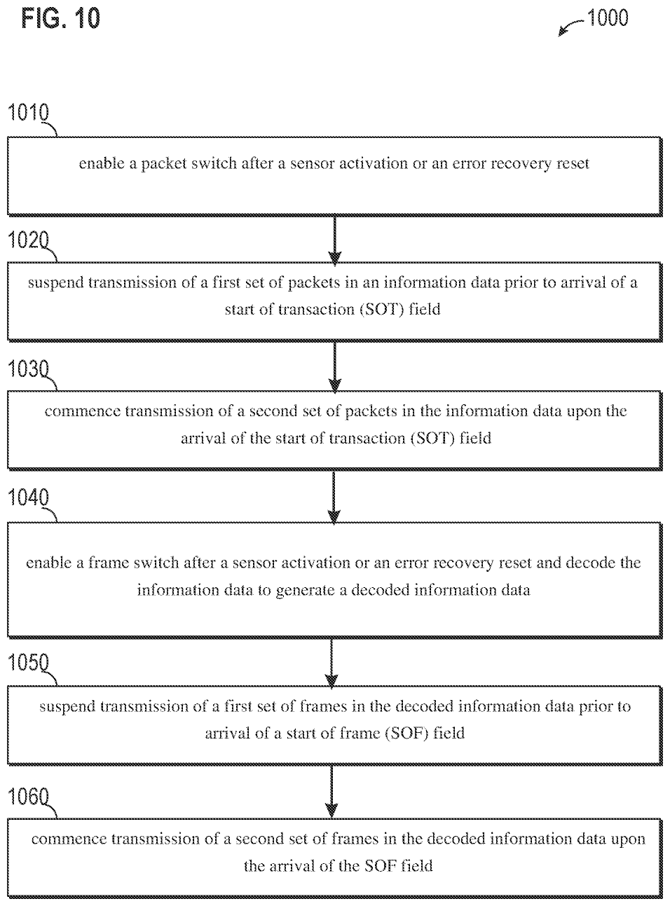

FIG. 10 illustrates an example flow diagram 1000 of self-synchronization of information data for an extended reality (XR) system with a smart combination switch. In block 1010, enable a packet switch after a sensor activation or an error recovery reset. That is, a packet switch is enabled after a sensor activation or an error recovery reset. In one example, the enabling is performed by a software module using a configuration signal. In one example, the sensor activation occurs when the sensor is powered on. In one example, the error recovery reset occurs when the XR system is rebooted.

In block 1020, suspend transmission of a first set of packets in an information data prior to arrival of a start of transaction (SOT) field. That is, the transmission of the first set of packets in an information data is suspended prior to arrival of the start of transaction (SOT) field. In one example, the suspension is performed by the packet switch. In one example, the first set of packets are received from a RX PHY layer interface. In one example the SOT field is received from the RX PHY layer interface. In one example, the suspended packets are dropped prior to arrival of the SOT field. In one example, there is a determination on whether there is arrival of the start of transaction (SOT) field. That is, there is determining on whether there is arrival of the start of transaction (SOT) field. In one example, the determining is based on detection of a first known data pattern in the SOT field. For example, the first known data pattern may be configured a priori to enablement of the packet switch.

In one example, the received packets are received over a single lane interface with one lane of information data at its output. In one example, the received packets are received over a multiple lane interface with more than one lane of information data at its output (i.e., two or more lanes). In one example, the multiple lane interface may introduce skew, i.e., timing offsets, among each lane at its output. In one example, deskewing of each lane of the multiple lane interface is performed.

In block 1030, commence transmission of a second set of packets in the information data upon arrival of the start of transaction (SOT) field. That is, transmission of the second set of packets in the information data is commenced upon arrival of the start of transaction (SOT) field. In one example, the commencing is performed by the packet switch. In one example, the second set of packets are received from the RX PHY layer interface. In one example the SOT field is received from the RX PHY layer interface. In one example, the commenced packets are complete packets. In one example, the received packets are received over a single lane interface with one lane of information data at its output. In one example, the received packets are received over a multiple lane interface with more than one lane of information data at its output. In one example, the multiple lane interface may introduce skew, i.e., timing offsets, among each lane at its output. In one example, deskewing of each lane of the multiple lane PHY lane interface is performed.

In block 1040, enable a frame switch after a sensor activation or an error recovery reset and use the CSID to decode the information data to generate a decoded information data. That is, a frame switch is enabled after a sensor activation or an error recovery reset, and the information data is decoded by the CSID to generate the decoded information data. In one example, the enabling is performed by a software module using a configuration signal. In one example, the sensor activation occurs when the sensor is powered on. In one example, the error recovery reset occurs when the XR system is rebooted.

In block 1050, suspend transmission of a first set of frames in the decoded information data prior to arrival of a start of frame (SOF) field. That is, the transmission of the first set of frames in the decoded information data is suspended prior to arrival of an start of frame (SOF) field. In one example, the suspension is performed by the frame switch. In one example, the frames are received from a CSI decoder. In one example the SOF field is received from the CSI decoder. In one example, the suspended frames are dropped prior to arrival of the SOF field. In one example, there is a determination of whether there is arrival of a start of frame (SOF) field. That is, there is determining on whether there is arrival of a start of frame (SOF) field. In one example, the determining is based on detection of a second known data pattern in the SOF field. For example, the second known data pattern may be configured a priori to enablement of the frame switch.

In block 1060, commence transmission of a second set of frames in the decoded information data upon arrival of the SOF field. That is, the transmission of the second set of frames in the decoded information data is commenced upon arrival of the SOF field. In one example, the commencing is performed by the frame switch. In one example, the second set of frames are received from the CSI decoder. In one example the SOF field is received from the CSI decoder. In one example, the commenced frames are complete frames.

In one aspect, one or more of the steps for providing self-synchronization of information data in FIG. 10 may be executed by one or more processors which may include hardware, software, firmware, etc. The one or more processors, for example, may be used to execute software or firmware needed to perform the steps in the flow diagram of FIG. 10. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing. for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order. and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus for implementing self-synchronization of information data, the apparatus comprising:
a packet switch;
a receive physical (RX PHY) layer interface coupled to the packet switch, the RX PHY layer interface configured to send the information data to the packet switch, and wherein the packet switch is configured to suspend transmission of the information data prior to arrival of a start of transaction (SOT) field and is configured to commence transmission of the information data upon arrival of the start of transaction (SOT) field.

2. The apparatus of claim 1, wherein the receive physical (RX PHY) layer interface is further configured to send the start of transaction (SOT) field to the packet switch.

3. The apparatus of claim 2, further comprising a software module coupled to the packet switch, wherein the software module is configured to enable the packet switch.

4. The apparatus of claim 3, wherein the packet switch is enabled after a sensor activation or an error recovery reset.

5. The apparatus of claim 2, further comprising a camera serial interface (CSI) decoder (CSID) coupled to the packet switch, wherein the CSID is configured to receive the information data from the packet switch.

6. The apparatus of claim 5, further comprising a frame switch coupled to the CSID, wherein the frame switch is configured to receive a start of frame (SOF) field from the CSID.

7. The apparatus of claim 6, wherein the CSID is further configured to decode the information data to generate a decoded information data to send to the frame switch.

8. The apparatus of claim 7, wherein the frame switch is further configured to suspend transmission of a first set of frames in the decoded information data prior to arrival of a start of frame (SOF) field.

9. The apparatus of claim 8, wherein the frame switch is further configured to commence transmission of a second set of frames in the decoded information data upon arrival of the SOF field.

10. The apparatus of claim 9, further comprising an image signal processor (ISP) coupled to the frame switch, wherein the ISP is configured to receive the decoded information data from the frame switch.

11. The apparatus of claim 10, wherein the ISP is further configured to process the decoded information data to generate a processed information data in a format compatible with an image display device.

12. The apparatus of claim 10, further comprising a software module coupled to the frame switch, wherein the software module is configured to enable the frame switch.

13. The apparatus of claim 12, wherein the frame switch is enabled after a sensor activation or an error recovery reset.

14. A method for implementing self-synchronization of information data, the method comprising:
determining whether there is arrival of a start of transaction (SOT) field;
suspending transmission of a first set of packets in an information data prior to arrival of the start of transaction (SOT) field; and
commencing transmission of a second set of packets in the information data upon the arrival of the start of transaction (SOT) field.

15. The method of claim 14, further comprising receiving the start of transaction (SOT) field from a receive physical (RX PHY) layer interface.

16. The method of claim 15, wherein the transmission of the second set of packets is over a single lane interface.

17. The method of claim 16, wherein the single lane interface includes one lane of information data at its output.

18. The method of claim 15, wherein the transmission of the second set of packets is over a multiple lane interface.

19. The method of claim 18, wherein the multiple lane interface includes two or more lanes of information data at its output.

20. The method of claim 14, further comprising determining whether there is arrival of a start of frame (SOF) field.

21. The method of claim 20, further comprising suspending transmission of a first set of frames in the information data prior to arrival of the start of frame (SOF) field.

22. The method of claim 21, further comprising commencing transmission of the second set of frames in the information data upon the arrival of the SOF field.

23. The method of claim 22, further comprising enabling a frame switch to commence the transmission of the second set of frames.

24. The method of claim 23, wherein the frame switch is enabled after a sensor activation or an error recovery reset.

25. The method of claim 24, further comprising enabling a packet switch to commence the transmission of the second set of packets.

26. The method of claim 25, wherein the packet switch is enabled after the sensor activation or the error recovery reset.

27. An apparatus for implementing self-synchronization of information data, the apparatus comprising:
means for determining whether there is arrival of a start of transaction (SOT) field;
means for suspending transmission of a first set of packets in an information data prior to arrival of the start of transaction (SOT) field; and
means for commencing transmission of a second set of packets in the information data upon the arrival of the start of transaction (SOT) field.

28. The apparatus of claim 27, further comprising:
means for determining whether there is arrival of a start of frame (SOF) field;
means for suspending transmission of a first set of frames in the information data prior to arrival of the start of frame (SOF) field; and
means for commencing transmission of the second set of frames in the information data upon the arrival of the SOF field.

29. A non-transitory computer-readable medium storing computer executable code, operable on a device comprising at least one processor and at least one memory coupled to the at least one processor, wherein the at least one processor is configured to implement self-synchronization of information data, the computer executable code comprising:
instructions for causing a computer to determine whether there is arrival of a start of transaction (SOT) field;
instructions for causing the computer to suspend transmission of a first set of packets in an information data prior to arrival of the start of transaction (SOT) field; and
instructions for causing the computer to commence transmission of a second set of packets in the information data upon the arrival of the start of transaction (SOT) field.

30. The non-transitory computer-readable medium of claim 29, further comprising instructions for causing the computer to perform the following:
determine whether there is arrival of a start of frame (SOF) field;
suspend transmission of a first set of frames in the information data prior to arrival of the start of frame (SOF) field; and
commence transmission of the second set of frames in the information data upon the arrival of the SOF field.
